(19) United States
(12) Patent Application Publication
(10) Pub. No.: US 2011/0072899 A1
(43) Pub. Date: Mar. 31, 2011

(54) SENSOR FOR DETERMINING HUMIDITY

(75) Inventors: Martin Hoffmann, Heiligenstedten (DE); Mike Schneider, Ilmenau (DE)

(73) Assignee: NXP. B.V., Eindhoven (NL)

(21) Appl. No.: 12/995,432

(22) PCT Filed: May 27, 2009
(86) PCT No.: PCT/IB2009/052215

§ 371 Date: Nov. 30, 2010

(30) Foreign Application Priority Data
May 30, 2008 (EP) 08104176.6

(51) Int. Cl. G01N 27/12

(52) U.S. Cl. 73/335.05

(57) ABSTRACT

The invention relates to a sensor (100) for determining humidity, the sensor comprising a system (10) of layers arranged superpositioned on each other. For rendering a sensor (10) available which allows of the measuring of integral variables necessary for determining the humidity, the invention proposes that the system (10) comprises a diffusion barrier (11) in the form of a water-permeable layer and a storage layer in the form of a water-absorbing and irreversibly water-binding layer, where the diffusion barrier (11) and the storage layer (12) are in direct contact with each other and the diffusion barrier (11) has a temperature-dependent permeability (16).

The invention relates to a sensor for determining humidity, the sensor comprising a system of layers arranged superpositioned on each other.

Sensors of the type defined in the opening paragraph are known from the state of the art, more particularly in an arrangement of capacitive sensors, in various embodiments.

A sensor of the type defined in the opening paragraph is disclosed in for example EP 0 403 994, which sensor comprises a capacitor from a planar system of layers superpositioned on each other. The system then comprises two metallic layers forming the electrodes as well as a humidity-sensitive polyamid film as a dielectric medium. At least one of the metallic layers though is steam-permeable.

Capacitive sensors of this type can in principle also be used in what are called RFID transponders. RFID tags can then be applied on or in the respective products and operate by means of inductively included power. The voltage generated in this manner can furthermore be used for supplying power to a suitable sensor which records the storage conditions of the respective product. The use of an RFID tag in the form of a label, extended by a respective sensor is disclosed for example in U.S. Pat. No. 6,806,898 B1.

According to U.S. Pat No. 6,806,898 B1 there is in addition to a known ID tag on a transponder a sensor for determining respective signals and a storage component which can passively store the variation of one or more physical or chemical environment variables.

More particularly in the packaging industry there is a need for such RFID tags extended by a sensor. In addition to an improvement of the readibility as a result of the removal of the necessity of a direct eye contact with the label it is possible to achieve an added value compared to the bar code by means of integrated sensor elements of the environment variables.

In the case of food packaging, however, often not the currently measured values are of interest. Rather the integral variables of the measured values play a decisive role because the storage of foodstuff, when stored for a rather long period of time with minor variations of the storage temperature, is more harmful to the quality than brief temperature variations. Therefore, an integration is necessary by periodical storage of the instantaneous values, which generally entails additional electronic elements. Furthermore, in terms of product security and product quality, a tag integrated with the packaging and whose sensor is activated and cannot be removed without damaging the packaging is aimed for in lieu of a stick-on label. In addition, the tag including sensor elements and memories is to have a certain robustness to outside mechanical loads in order not to suffer any damage during transport and tactile handling.

Previous solutions such as for example the so-called smart-active label are extensions to the known smart label, flat RFID tags with a planar wound antenna which are extended by an independent energy source. The energy source which is in most cases present in the form of an accumulator has for its object to supply the necessary power to the external sensor elements with a data logger and an optional display. For integration with a packaging material, however, the solutions based on the use of accumulators are unsuitable because, compared with the bar code, they neither satisfy the conditions as regards costs nor as regards the additional space necessary for the integration with the packaging material.

Therefore, it is an object of the present invention to provide a sensor of the type defined in the opening paragraph which allows of measuring the integral variables necessary for determining the humidity.

This object is achieved with the characteristic features as claimed in claim 1. Advantageous embodiments of the invention are revealed in the dependent claims.

The invention provides that the arrangement of a diffusion barrier has the form of a water-permeable layer and a storage layer in the form of a water-absorbing and irreversibly water-binding layer, where the diffusion barrier and the storage layer are in direct contact with each other and the diffusion barrier has a temperature-dependent permeability.

The central idea of the invention is to use water as a diffunding medium in a defined permeable membrane, as is represented by the diffusion barrier, for the integration of temperature over time. It is a known fact that the diffusion is a process which depends on temperature and time and thus represents a natural temperature-time-integrator.

According to the invention the diffusion barrier has a permeability to water. The permeability of the diffusion barrier is also temperature-dependent. Thus the diffusion barrier in a way performs the function of a valve, which opens at a rising temperature and transfers more water to the underlying layer. Underneath the barrier layer there is the storage layer which absorbs and permanently binds the diffunded quantity of water. Thus, if water contacts the diffusion barrier, depending on the temperature the water is led to the underlying storage layer and stored there. Via a tested measuring operation such as for example a resistance measuring the storage surface is read out i.e. the electrical resistance of the storage layer is measured. The higher the humidity of the surrounding air is, the faster the resistance will drop, as a result of which a humidity-time integral can be drawn up and evaluated.

Suitable diffusion barriers are represented by polymers such as poly(4-methyl-1-pentene) (PMP, TPX) or polyvinylidene chloride (PVDC) of which the minimum permeability is between 0.6 and 1.5 g/m²/d at room temperature, where d is the unit symbol of the day. Preferably a nafion layer is used as a storage layer. With a permeability of 1 g/m²/d (=100 μm/cm²/d) and a capacity of the 10 μm thick nafion layer of approximately 540 μg/cm² the storage layer is completely full within 5 to 6 days and a minimum resistance is reached. The temperature-dependent permeability thus implies also the storage of the water molecules in the storage layer as a function of time.

The sensor according to the invention thus represents the experimental prerequisite for determining the temperature-time integral or a humidity-time integral respectively.

Since at lower temperatures both the density of the liquid and the permeability of the diffusion barrier diminishes as a result of the reduced thermal proper motion, it may be assumed that less liquid ends up in the storage layer and the resistance after 5 days has a clearly larger value.

Further advantages of the sensor according to the invention are the irreversible storage of the measured values as well as the completely passive function i.e. the batteriless functioning of the sensor. In addition, without a change of the chemical composition of the diffusion barrier its properties can for example be adjusted by changing the geometry.

With the sensor according to the invention it is furthermore advantageous when the diffusion barrier is a polymer layer. Polymers have the advantage that they show a permeability that depends on temperature.

An advantageous embodiment of the invention provides that the diffusion layer has an anorganic top coat. The permeability of polymer layers can usually be varied only by means of their chemical composition. Moreover, in products having a longer durability at room temperature the permeability of polymer layers is often still clearly too high. Since a decisive factor for the permeability is the free area exposed to the moisture, it is appropriate within the scope of the invention to minimize the effective free area by applying a top coat. The top coat then preferably also has an adjustable porosity.

A practicable variant of the invention provides that the storage layer is provided with contacts for a resistance measuring. Additional electronic elements may be largely omitted for a resistance measuring.

A further advantageous embodiment of the invention provides that the storage layer contains hygroscopic acids. Since the water absorption of most polymers is only an intramolecular storage of the water molecules and thus a reversible operation, it is advantageous to mix in acids in the top coat, which acids have a strongly hygroscopic effect and irreversibly bind water.

It is also effective to have a mixture of nafion, which is a superb conductor for hydrogen ions and molecular water, and a hygroscopic acid such as calcium chloride or lithium chloride in crystalline or ionised form.

In addition the invention provides a method for determining humidity in which liquid diffuses through a diffusion barrier with time-dependent permeability into a storage layer to be stored there. The method according to the invention creates the condition that a temperature-time integral of a liquid can be determined.

The invention will be elucidated more fully below while reference is made to the appended drawing figure, in which:

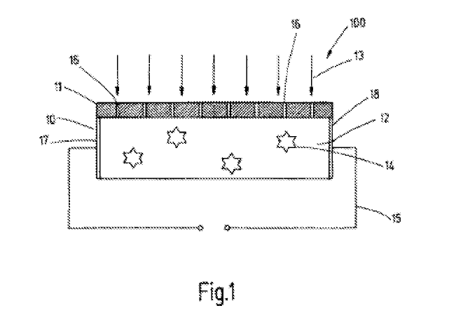

FIG. 1 shows a sensor according to the invention.

In FIG. 1 is shown a sensor according to the invention which is referenced by reference numeral 100.

The sensor 100 comprises a system 10. The system 10 comprises a diffusion barrier 11 in the form of a temperature-dependent layer which is permeable to water and which has a temperature-dependent permeability 16. The diffusion barrier 11 is deposited on a storage layer 12. The storage layer 12 is in the form of a water-absorbing and irreversibly water-binding layer. The diffusion barrier 11 and the storage layer 12 are in direct contact with each other. The diffusion barrier 11 is at the top freely accessible with the surrounding medium in the form of the liquid 13. The temperature dependence of the diffusion barrier 11 provides that the diffusion barrier 11 performs the function of a valve that opens with a rising temperature and supplies more liquid 13 to the storage layer 12 disposed underneath the diffusion barrier 11.

The storage layer 12 present underneath the diffusion barrier 11 absorbs the liquid 13 diffused by the diffusion barrier 11 in that it irreversibly binds the liquid 13. The absorption of the liquid 13 by the storage layer 12 is mostly an intramolecular storage of the water molecules of the liquid 13 and thus represents an irreversible process which is to say that the storage of the water molecules of the liquid 13 is attended with the adjustment of a dynamic equilibrium after an initial state of non-equilibrium.

In order to bring about a fast adjustment of the dynamic equilibrium there are within the storage layer 12 additions of substances 14 which have a strongly hygroscopic effect and irreversibly bind the water molecules of the liquid 13, for example by binding as a crystal water in acids. In the embodiment shown here the storage layer 12 is a mixture of nafion which is a superb conductor for hydrogen ions and molecular water, and a hygroscopic acid which in the embodiment shown here is present as calcium chloride or lithium chloride in crystalline or ionised form.

The storage layer 12 has contacts 17, 18 on either one of the two sides for measuring the resistance 15. For the resistance measuring 15 the storage layer 12 is read out which is to say that the electrical resistance of the storage layer 12 is measured. The resistance of the storage layer 12 then drops together with the quantity of the absorbed water of the liquid 13. The diffusion barrier 11 may additionally have a hygroscopically reversible layer such as nafion. The nafion layer then absorbs water of the liquid 13 in proportion to the current humidity of the surrounding air and renders it available above the diffusion barrier 11. When there is a varying moisture content on the surface of the sensor 100, over a time span various amounts of water are delivered to the storage layer 12 by the nafion layer not shown in FIG. 1 via the diffusion barrier 11.

### REFERENCE LIST

100 sensor
10 system
11 diffusion barrier
12 storage layer
13 liquid
14 admixtures
15 resistance measuring
16 permeability
17 contact
18 contact

1. A sensor for determining humidity, the sensor comprising a system of layers superpositioned on each other, the system has a diffusion barrier which has the form of a water-permeable layer and a storage layer in the form of a water-absorbing and irreversibly water-binding layer, where the diffusion barrier and the storage layer are in direct contact with each other and the diffusion barrier has a temperature-dependent permeability.

2. A sensor as claimed in claim 1, wherein the storage layer is a nafion layer.

3. A sensor as claimed in claim 1, wherein the diffusion barrier is a polymer layer.

4. A sensor as claimed in claim 1, wherein the diffusion barrier has an inorganic top coat.

5. A sensor as claimed in claim 1, wherein the storage layer is provided with contacts for a resistance measuring.

6. A sensor as claimed in claim 1, wherein the storage layer has admixtures in the form of hygroscopic acids.

7. A sensor as claimed in claim 6, wherein the acids are calcium chloride and/or lithium chloride.

8. A sensor as claimed in claim 1, wherein the top coat has adjustable porosity.

9. A method for determining humidity, wherein liquid diffuses through a diffusion barrier with time-dependent permeability into a storage layer in order to be stored there.

10. A method as claimed in claim 9, wherein the liquid diffuses through a polymer layer.

11. A method as claimed in claim 9 that wherein the liquid is stored in a nafion layer.

12. A method as claimed in claim 9, wherein the liquid diffuses through a polymer layer covered by an anorganic top coat.

13. A method as claimed in claim 9, wherein the resistance of the storage layer is measured.

14. A method as claimed in claim 9, wherein the diffusion barrier has an adjustable porosity.

15. A use of a sensor as claimed in claim 1 and a method as claimed in claim 9 in the field of foodstuffs.
